(19) United States
(12) Patent Application Publication
(10) Pub. No.: US 2025/0091312 A1
(43) Pub. Date: Mar. 20, 2025

(54) FLEXIBLE MULTI-WALL SHEET

(71) Applicant: Christopher Garrison Wark

(72) Inventor: Christopher Garrison Wark

(21) Appl. No.: 18/370,716

(22) Filed: Sep. 20, 2023

(51) Int. Cl. B32B 3/20; A01G 9/14; B32B 27/08; E06B 7/00

(52) U.S. Cl. CPC B32B 3/20; B32B 27/08; A01G 9/1415; B32B 2307/41; B32B 2307/414; B32B 2307/542; E06B 7/00

(57) ABSTRACT

The present invention is a multi-wall sheet made of a plastic with a high shear modulus intended to provide physical protection, structural support, and thermal insulation in applications where a small bending radius for the multi-wall plastic sheet is desired. The multi-wall configuration includes a generally flat outer single sheet and a contoured inner single sheet separated by a series of ribs of similar plastic material to form a connected row of longitudinal cavities or “channels”. The inner wall is contoured in a concave manner to form a relief between each rib. When the multi-wall sheet is flexed, each relief distorts to minimize stress in the transverse direction while maintaining high rigidity in the longitudinal direction. In another embodiment of the present invention, multiple single sheets separated by ribs and contoured similarly to that of the inner wall are added between the contoured inner wall and non-contoured outer wall.

### TECHNICAL FIELD

The present invention relates generally to multi-wall sheet used to create or protect an enclosure, and more specifically to applications in which it is desirable to allow a small bending radius in a thermoplastic multi-wall sheet.

### BACKGROUND

A type of commercially available insulating sheet is referred to as “multi-wall” plastic sheet. In its simplest form, this type of sheet has 2 walls and is commonly referred to as “twin-wall” plastic sheet. In this structure, two or more parallel single-sheet layers of thermoplastic material are spaced apart from each other by continuous, periodically spaced “rib” structures of similar thermoplastic material that determine, along with the thickness of each single-sheet layer, the overall thickness dimension of a multi-wall sheet. The two outermost layers are often distinguished from each other as an “interior wall” and an “exterior wall”, depending on the details of the multi-wall sheet structure and possible surface treatment of one or both outer layers that determine which wall is intended to face the interior of an enclosure and which wall is intended to face exterior to an enclosure. The known and commercially available structures of multi-wall sheet have perpendicular ribs, diagonal ribs or certain combinations of perpendicular and diagonal ribs between and separating the parallel single-sheet layers. When a multi-wall sheet is viewed in cross-section along the direction of extrusion, a series of ribs separating two layers create a row of longitudinal cavities, or “channels”.

Fabrication of multi-wall sheets typically include extrusion of opaque or translucent thermoplastic material, and bonding of one or more layers to each other may also be included in the fabrication process. Transparent or translucent materials are frequently desired and are known to be prepared from thermoplastic resins having the necessary degree of light transmission, such as polycarbonate or acrylic resins.

Those practiced in the art will appreciate that the ribs increase the overall rigidity of a multi-wall sheet.

Those practiced in the art will appreciate that each row of channels creates an insulating layer between the interior and exterior walls. Each row of channels creates an additional insulating layer between each adjacent pair of single-layer sheets, further increasing the R-value of the multi-wall sheet.

Multi-wall sheet is used as light-weight insulating construction elements for various types of enclosures and structural support. Multi-wall sheet may be opaque or translucent. Common applications for the translucent form of multi-wall sheet include green houses, sky lights, and other types of window applications where vision quality is not critical. Common applications for opaque forms of multi-wall sheet include signs and support for displays and artwork.

This concept of multi-wall plastic sheet or panels has been described in prior art since the early 1960's with one example being U.S. Pat. No. 3,341,395 in which two plastic sheets are separated by plastic plaiting to form the ribs and each of these components are fabricated separately rather than as a single extrusion. As plastic extrusion techniques advanced, improvements to the structure, rigidity, and other performance parameters of multi-wall panels were suggested in the prior art, with an example being U.S. Pat. No. 4,443,987.

If forces are applied to a twin-wall sheet as shown in FIG. 6A of U.S. Pat. No. 5,972,475, where a horizontal twin-wall sheet is supported along two equal, parallel longitudinal lengths of the lower wall and a force is applied on the upper wall in the same length and parallel to the two supports, the upper wall will be in tension and the lower wall will be in compression, resulting in a deflection shown by “y”. The Shear Modulus, or Modulus of Rigidity, “G”, of the overall structure can be calculated using:

$$G := \frac{1}{\frac{4 DLy}{FW} - \frac{{W}^{2}}{6 EDt}}$$

Where: G=Shear Modulus of the twin-wall sheet, N/mm2
   E=Modulus of Elasticity of the material, N/mm2
   F=force on the twin-wall sheet sample, N
   D=total thickness of the twin-wall sheet, mm
   W=distance between the two supports, mm
   L=length of sheet sample, mm
   t=average wall thickness, mm
   y=deflection resulting from applied force, mm

Polycarbonate is the most commonly used thermoplastic in the fabrication of this type of product because of its high rigidity, light weight, and desirable optical qualities. Available products with the simplest configuration of polycarbonate twin-wall sheet comprised of a single row of channels formed only by ribs perpendicular to the walls have a typical transverse Shear Modulus in a range of approximately 0.3-0.6 N/mm2, depending largely on the spacing, length, and thickness of the ribs. Various combinations of angled ribs can increase G substantially, but no other change in rib angle can reduce G from that of its simplest form.

The Shear Modulus in the longitudinal direction of polycarbonate twin-wall sheet is typically in the range of 0.007-0.009 N/mm2, resulting in a recommended maximum bending radius of approximately 150 times the overall twin-wall sheet thickness, “D”. A common minimum twin-wall sheet thickness of 6 mm may have a bending radius of approximately 900 mm which limits its use to large radius curves found in applications such as high tunnel green houses. One example of the prior art where the longitudinal Shear Modulus is critical is a storm resistant window cover described in U.S. Pat. No. 5,595,233.

In the transverse direction, the maximum bending radius may be greater than 4 m for a twin wall sheet with D=6 mm before a catastrophic failure occurs in which the innermost walls or the ribs begin to collapse causing permanent plastic deformation of the walls or ribs, thus manufacturers' recommendations that polycarbonate twin-wall flexure only be attempted in the longitudinal direction.

The relatively high rigidity of currently available multi-wall sheet made of materials such as polycarbonate, acrylic or high-density PVC make it unsuitable for many applications that require bending to small radius curves such as cylindrical plant protectors, small greenhouses with curved roofs, small hoop houses, crop tunnels, and roll-up displays where a bending radius of less than 300 mm may be desired. The prior art for this type of application can be seen in the form of a single corrugated sheet curved over a single flat sheet as in U.S. Pat. No. 4,068,423 or two separated coaxial sheets as in U.S. Pat. No. 2,626,483 or U.S. Pat. No. 5,815,991. One invention that addresses the desire for high longitudinal rigidity while being flexible in the transverse direction is U.S. Pat. No. 5,323,566; however, it does not have the form of a true twin-wall sheet in that the outer wall is periodically arcuated in such a way that eliminates the ribs as well as the desired continuous insulation characteristics.

Twin-wall sheet can be created using a more flexible material such as a low-density polypropylene, polyethylene, or plasticized PVC; however, doing so reduces the Shear Modulus of the twin-wall sheet in both the longitudinal and transverse directions, making it less desirable for applications where high rigidity is still advantageous in one direction.

Other inventions include corrugations or curved elements that appear to allow a certain amount of flexure such as U.S. Pat. Nos. 3,039,574, 7,987,647, U.S. Publication 2010/0325991 and U.S. Publication 2019/0001609; however, these invention elements are not described as being flexible and the systems which comprise them are clearly intended to have high rigidity in all directions. U.S. Publication 2015/0152635 does contain a somewhat flexible element; however, this element is described as an elastic film fully contained between two somewhat flat outer walls that are highly rigid in all directions of their respective planes in order to serve the purpose of the function of the invention, and it should be apparent to those skilled in the art that the panel configuration includes rib elements that would greatly limit a reduction in shear modulus for the system.

The present invention addresses the problem of prior art multi-wall sheet formed entirely from a high shear modulus thermoplastic which incorporates two somewhat flat and parallel outer walls separated by a series of rib structures, catastrophically failing upon required flexure in applications requiring a small bending radius in only one direction. The present invention addresses this problem by incorporating into the transverse profile of a multi-wall sheet formed from a high shear modulus thermoplastic a contoured interior wall such that the interior wall can collapse elastically with some bending resistance, but without resulting in permanent plastic deformation, in order to allow a desired curvature in the transverse direction while retaining a desired high rigidity in the longitudinal direction and while maintaining an overall thermal R-value characteristic of typical high shear modulus multi-wall sheet of similar material.

### SUMMARY OF THE INVENTION

In one embodiment of the present invention, a twin-wall sheet has the form of an outer single sheet of thermoplastic material with a sufficiently high Shear Modulus and an inner single sheet of similar thermoplastic material generally parallel to the outer sheet and the inner and outer single sheets separated by a series of ribs of similar thermoplastic material to form a connected row of longitudinal cavities or “channels”. In the case of the twin-wall sheet being in a generally flat or un-flexed position, the outer sheet is flat while the form of the inner sheet is contoured in a concave manner to form a relief between each rib. When the twin-wall sheet is flexed, each relief distorts to minimize stress in the transverse direction while maintaining high rigidity in the longitudinal direction. The plastic material used in the fabrication of the twin-wall sheet may be opaque or translucent.

In another embodiment of the present invention, a plurality of single thermoplastic sheets contoured similarly to that of the inner wall are added in a generally parallel manner between the contoured inner and flat outer walls. A series of ribs of similar thermoplastic material are located between each adjacent single sheet to form an array of multiple attached rows of longitudinal channels. When this multiple layer form of the present invention is flexed, all of the arcs formed in the multiple layers simultaneously distort to minimize bending stress in the transverse direction while maintaining high rigidity in the longitudinal direction.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the views.

FIG. 1 is an isometric view of the present invention.

FIG. 2 is a sectional view in the longitudinal direction of extrusion of the present invention in a flexed, as well as unflexed, position.

FIG. 3 is a sectional view in the longitudinal direction of extrusion of an embodiment of the present invention in which a plurality of additional single sheets is incorporated between an outer wall and an inner wall.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present invention is a twin-wall sheet that incorporates a generally flat outer wall and a contoured inner wall.

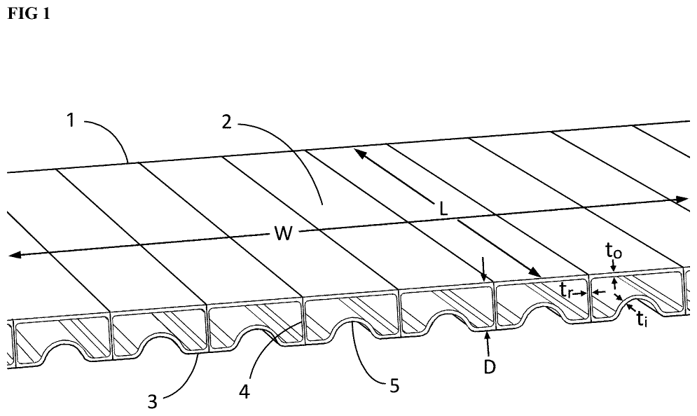

Referring to FIG. 1, an orthogonal view of the present invention 1 in a flat, or un-flexed, position is shown. The twin-wall sheet is comprised of a first wall 2; a second wall 3 that is generally parallel to and of the same length and width as the first wall 2, and a plurality of ribs 4 located at periodic intervals between, perpendicular to, and attached to the first wall 2 and second wall 3 to establish the overall thickness of the twin-wall sheet shown as “D”. The first wall 2 is generally flat in this position, has a longitudinal length shown as “L”, transverse width shown as “W”, thickness shown as “tₒ”, and typically serves as the outer wall of the twin-wall sheet 1 in applications in which the twin-wall sheet serves as a covering or enclosure, or any other application where the purpose of utilizing the twin-wall sheet is to provide an insulated separation between a generally interior environment and an exterior condition. The form of the second wall 3 has a thickness shown as “tᵢ” and incorporates periodic concave relief arcs 5 between each pair of adjacent ribs 4 which have thickness “tᵣ” and typically serves as the inner wall of the twin-wall sheet 1 in applications in which the twin-wall sheet serves as a covering or enclosure, or any other application where the purpose of utilizing the twin-wall sheet is to provide an insulated separation between a generally interior environment and an exterior condition. The preferred form of the curvature of the concave reliefs is a filleted half-circle; however, other circular section, elliptical or higher-order curve variations with different degrees of fillet may also be used for specific optimization of bending stress characteristics of the present invention. The specific dimensions and overall shape of the twin-wall sheet 1 in all its forms are generally unlimited, however, those practiced in the art will appreciate that specific dimensions are dictated by its functionality and a particular application.

Referring to FIG. 2, a sectional view in the longitudinal direction of extrusion of the present invention in a flexed position, as well as an unflexed position, is shown. FIG. 2 shows the extrusion profile of the flexed position of the present invention 1a superimposed on the unflexed position of the present invention 1 in order to demonstrate the intent of the functionality of the present invention. Applying an equal pair of forces to the extents of the outer wall 2 along the longitudinal direction while supporting the inner wall 3 in a manner that maintains static equilibrium with the forces on the outer wall 2, causes tension, “T”, transversely along the outer wall 2 and compression, “C”, transversely along the inner wall, between the applied forces, further causing the relief portions 5 of the inner wall to distort, resulting in an overall transverse curvature if radius “R”. Since a minimum R is largely dependent on the depth, average radius, and periodicity of each relief 5, the Shear Modulus is used only to describe the initial bending resistance and it approaches the Modulus of Elasticity of the thermoplastic material as the thickness of the inner wall approaches zero. The Shear Modulus is proportional to the total thickness of the twin-wall sheet, D; an average of the wall thicknesses tₒ, tᵢ, and tᵣ; the periodicity of the ribs 4; and the Modulus of Elasticity of the material. The present invention is anisotropic such that its rigidity in the longitudinal direction is similar to that of the prior art.

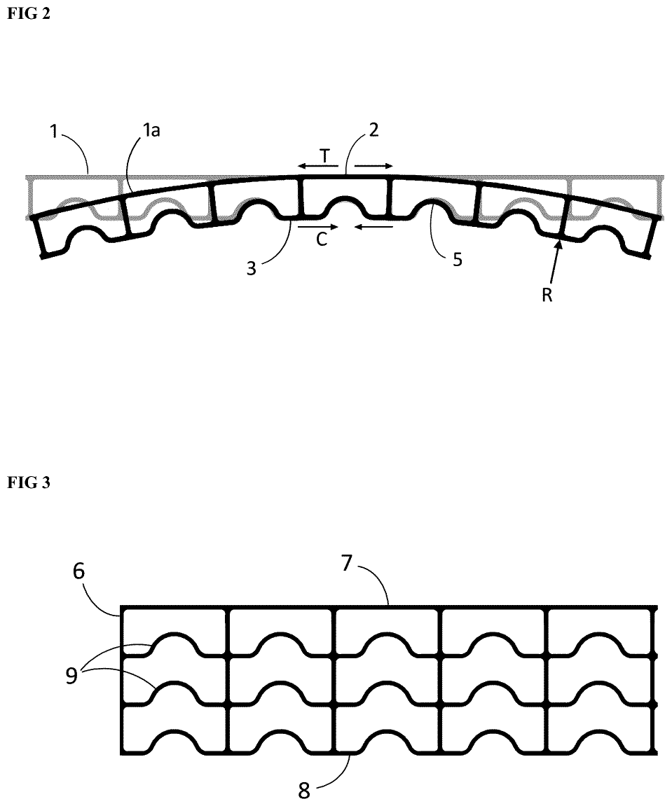

Referring to FIG. 3, a sectional view in the longitudinal direction of extrusion of an embodiment of the present invention 6 in which a plurality of intermediate single sheets 9 is incorporated between an outer wall 7 and an inner wall 8 is shown. When the form of this embodiment is flexed around a longitudinal axis, the reliefs incorporated into the form of each intermediate single sheet distort simultaneously with each other as well as the reliefs incorporated into the form of the inner wall 8. The radii and depths of the intermediate sheet reliefs may differ between intermediate sheets and from those of the inner wall, depending on the intermediate sheet spacing and rib periodicity, in order to minimize overall distortion and bending resistance of the twin-wall sheet. The specific dimensions and overall shape of the multi-wall sheet 6 in all its forms are generally unlimited, however, those practiced in the art will appreciate that specific dimensions are dictated by its functionality and a particular application.

The present invention can be constructed of a wide range of translucent or opaque thermoplastic materials including but not limited to polycarbonate, acrylic, unplasticized PVC, PET, or high-density polypropylene. Those practiced in the art will appreciate that the present invention is typically formed through extrusion and can alternatively be formed through other techniques including, but not limited to, 3-D printing or ultrasonic welding as dictated by the specific application.

Specific examples of applications of the present invention include small greenhouses with curved roofs, cylindrical plant protectors, hoop houses, crop tunnels, roll-up semi-rigid signs, and structures such as room dividers or display frames where a small bending radius may be desired.

It should be emphasized that the above-described embodiments of the present invention, particularly any “preferred” embodiments, are merely possible examples of implementations set forth for a clear understanding of the principles of the invention. Many variations and modifications may be made to the above-described embodiments of the invention without substantially departing from the spirit and principles of the invention. All such modifications are intended to be included herein within the scope of this disclosure and the present invention.

I claim:

1. A multi-wall sheet made of a thermoplastic with a relatively high shear modulus, having a structure comprising:
a first wall comprising a single generally flat sheet;
a second wall comprising a single sheet generally parallel to, extending a length of, and separated from the first wall, having a transverse contour of a form incorporating a series of alternating flat and arced sections each with an apex toward the first wall and extending a length of the second wall; and
a plurality of ribs located between, perpendicular to, and connected to the first wall and second wall and each rib equidistant between two adjacent arcs in the transverse contour of the second wall and extending the length of the first and second walls in the longitudinal direction of the arcs.

2. A multi-wall sheet made of a thermoplastic with a relatively high shear modulus, having a structure comprising:
a first wall comprising a single generally flat sheet;
a second wall comprising a single sheet generally parallel to, extending a length of, and separated from the first wall, having a transverse contour of a form incorporating a series of alternating flat and arced sections each with an apex toward the first wall and extending a length of the second wall;
an intermediate single sheet between, generally parallel to, extending the length of the second wall, and separated from the first wall, having a transverse contour of a form similar to the second wall and having an apex of each arc generally aligned to an apex of each arc of the second wall and extending a length of the intermediate sheet;
a plurality of ribs located between, perpendicular to, and connected to the first wall and the intermediate sheet and each rib equidistant between two adjacent arcs in the transverse contour of the intermediate sheet and extending the lengths of the first wall and intermediate sheet; and
a plurality of ribs located between, perpendicular to, and connected to the second wall and the intermediate sheet and each rib equidistant between two adjacent arcs in the transverse contour of the second wall and extending the lengths of the intermediate sheet and second wall.

3. A multi-wall sheet made of a thermoplastic with a relatively high shear modulus, having a structure comprising:
a first wall comprising a single generally flat sheet;
a second wall comprising a single sheet generally parallel to, extending a length of, and separated from the first wall, having a transverse contour of a form incorporating a series of alternating flat and arced sections each with an apex toward the first wall and extending a length of the second wall;
a plurality of intermediate single sheets between, generally parallel to, extending the lengths of, and separated from the first wall and second wall, each having a transverse contour of a form similar to the second wall and having an apex of each arc of each intermediate sheet generally aligned to an apex of each arc of the second wall and extending a length of the plurality of intermediate sheets;
a plurality of ribs located between, perpendicular to, and connected to the first wall and an intermediate sheet adjacent the first wall and each rib equidistant between two adjacent arcs in the transverse contour of the intermediate sheet adjacent the first wall and extending the length of the first wall and intermediate sheets;
a plurality of ribs located between, perpendicular to, and connected to adjacent intermediate sheets and each rib equidistant between two adjacent arcs in the transverse contour of each intermediate sheet and extending the length of the plurality of intermediate sheets;
a plurality of ribs located between, perpendicular to, and connected to the second wall and an intermediate sheet adjacent the second wall and each rib equidistant between two adjacent arcs of the transverse contour of the second wall and extending the lengths of the second wall and plurality of intermediate sheets.
